(19) United States
(12) Patent Application Publication
(10) Pub. No.: US 2006/0036469 A1
(43) Pub. Date: Feb. 16, 2006

(54) Kit and method for evaluating proper administration of medications

(76) Inventor: Laurie Munday, San Diego, CA (US)

Correspondence Address: DUCKOR SPRADLING METZGER, 401 WEST A STREET, SUITE 2400, SAN DIEGO, CA, 92101-7915, US

(21) Appl. No.: 10/915,068

(22) Filed: Aug. 10, 2004

(51) Int. Cl. G06Q 10/00

(52) U.S. Cl. 705/2

(57) ABSTRACT

A method and kit as disclosed relate to at least one medication order display bearing medication indicia and administration indicia, and at least one medication administration record worksheet display bearing a transcription area and a medication administration record area. A group of practice medications including medications designated by the medication indicia are employed. The user is instructed to enter transcription information in the transcription area of the worksheet based on the medication indicia and the administration indicia of the medication order display. The user is also instructed to enter information in the medication administration record area based on the transcription information and selected ones of the practice medications.

### FIELD OF THE INVENTION

The present invention relates in general to a kit and method for evaluating the proper administration of oral medications. It more particularly relates to such a kit and method, which may, for example, be used in an educational setting for students learning how to properly administer medications.

### BACKGROUND ART

There is no admission that the background art disclosed in this section legally constitutes prior art.

In the past, students in nursing, pharmacy, medical assistance and other allied health professions have been taught the proper administration of medications by administering practice medications to fellow students or mannequins. Practice simulated medications were prepared to the practice “patients” and are recorded on a sheet similar to a record sheet actually used in a hospital. Under the scrutiny of a teacher, the proper administration skills were learned and problems such as administering improper medications or the wrong dosage were taught to be avoided. The practice medications may be substances, such as vitamin capsules to simulate oral medications, or colored water to simulate an injectable medication.

In one example, the students would learn proper administration of the medication by concentrating on selecting the correct medication to be administered to the correct patient. Also, the frequency of the administration, such as daily or other period of time to administer the medication, must be carefully considered. Additionally, the person being tested must make certain that the correct patient receives the medication in the proper manner. In this regard, the route, such as by mouth or by injection ordered by the physician must be followed; and the proper dose must be administered.

### BRIEF DESCRIPTION OF THE DRAWINGS

The following is a brief description of the drawings:

FIG. 1 is a diagrammatic view of a medication administration, which is constructed in accordance with an embodiment of the invention;

FIG. 2 is an enlarged scale face, fragmentary view of the back side of a blistered pack for a medication of the kit of FIG. 1; and

FIGS. 3, 4, 5, 6 and 7 are enlarged views of the displays forming a portion of the kit of FIG. 1.

### DETAILED DESCRIPTION OF CERTAIN EMBODIMENTS OF THE INVENTION

A method and kit as disclosed relate to at least one medication order display bearing medication indicia and administration indicia, and at least one medication administration record worksheet display bearing a transcription area and a medication administration record area. A group of practice medications including medications designated by the medication indicia are employed. The user is instructed to enter transcription information in the transcription area of the worksheet based on the medication indicia and the administration indicia of the medication order display. The user is also instructed to enter information in the medication administration record area based on the transcription information and selected ones of the practice medications.

According to one disclosed embodiment of the invention, a kit is provided for the evaluation of the proper administration of the medications. The kit may include at least one medication order display bearing medication indicia and administration indicia. The kit may also include at least one medication administration record worksheet display bearing a transcription area and a medication administration record area. Furthermore, the kit may also include a group of practice medications including medications designated by the medication indicia.

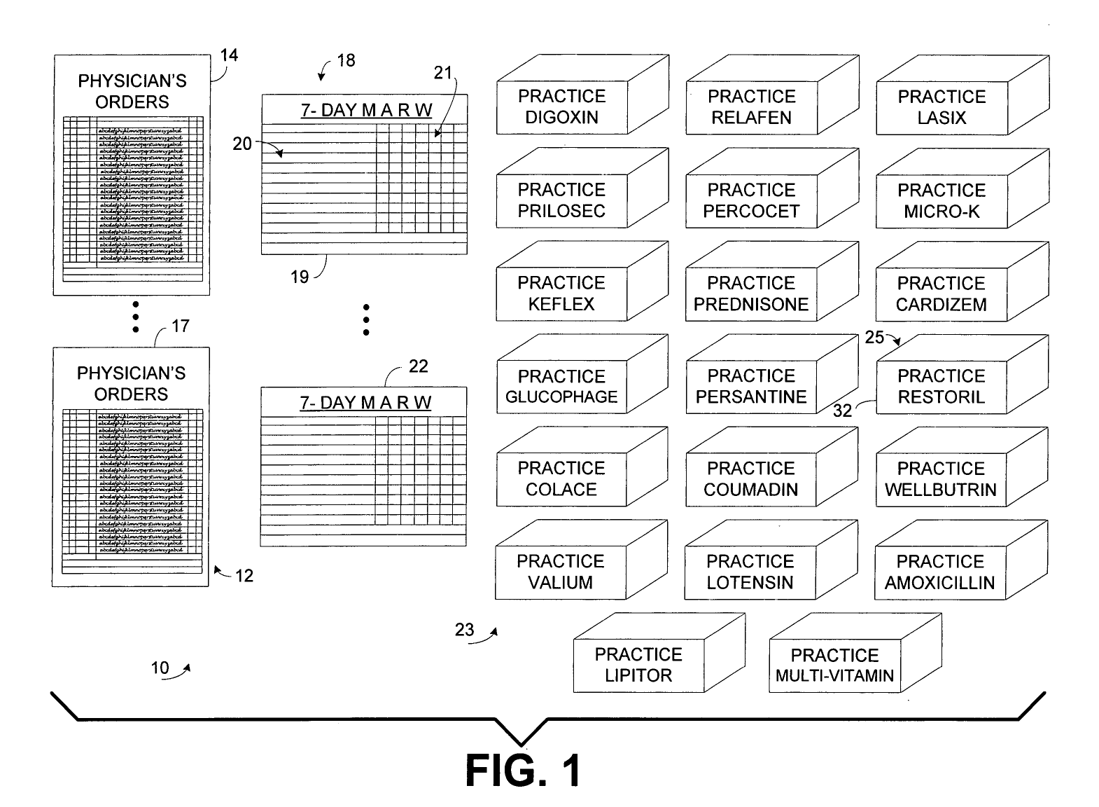

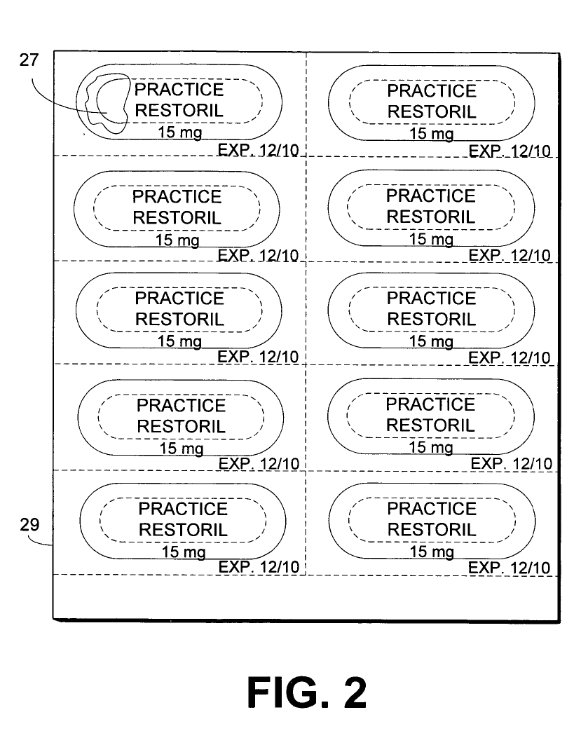

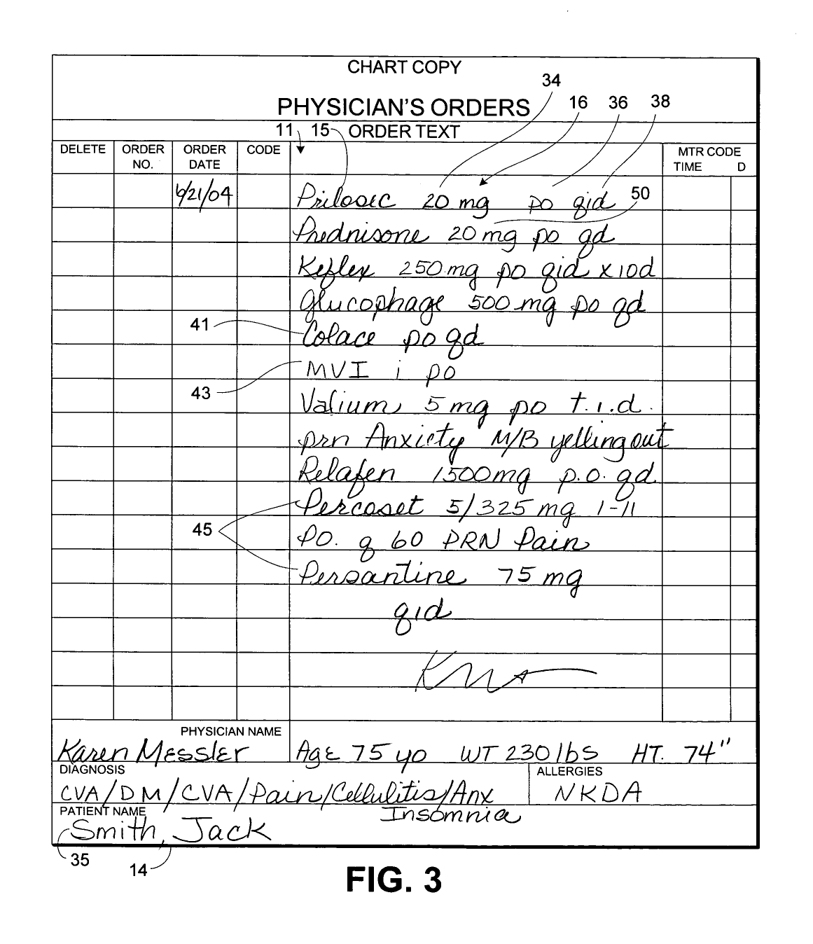

Referring now to the drawings, and more particularly to FIGS. 1 and 2 thereof, there is shown a kit generally indicated at 10 for evaluating the proper administration of medications, the kit being constructed in accordance with an embodiment of the invention. The kit generally comprises a plurality of medication order displays generally indicated at 12 including a physician ordered display 14. As shown in FIG. 3, the physician order display 14 includes a series of one or more medication indicia generally indicated at 11, and includes a medication indicia 15, which describes the name of the medication; such, for example, as Prilosec. The display 14 also includes administration indicia generally indicated at 16. It should be understood that other types of medication orders such as pharmacy, dental, veterinarian or other orders, are contemplated within the spirit and scope of the present invention.

The plurality of physician order displays 12 may include a number of such displays for different patients. For example, as shown in FIG. 1, there is also another physician order display 17 for a different patient than the one corresponding to the physician order display 14.

The kit also includes a group of medication administration record worksheets generally indicated at 18, which group includes a worksheet display 19, which includes a transcription area 20 and a medical administration record area 21. The areas 20 and 21 may be filled out by the person administering the medications as hereinafter described in greater detail. The worksheet 18 is associated with the physician order 14 for a given patient. Similarly, a medication administration record worksheet 22 is associated with the physician order display 17 for another patient.

As presently contemplated, the medication order displays and/or the medical administration record worksheet displays are in the form of printed sheets of paper. However, it may become apparent to those skilled in the art that other media may also be employed in accordance with other embodiments of the invention. For example, computer generated images of the displays may be used. The displays may be stored in storage media such as compact discs, hard drives and others. Also, such displays may be presented and filled out using a computer, a terminal, or other, and may be done so locally or on-line with a remote database, server, or other. Other implementations of the displays may also become apparent to those skilled in the art.

The kit 10 may also include a group of practice medications generally indicated at 23, which may include, for example, a practice Restoril 25 contained within a Restoril box 32. As shown more particularly, in FIG. 2, a practice Restoril capsule 27 is stored within a conventional blister package 29, which in turn is stored within a box 32 (FIG. 1). In this regard, the box 32 may contain a plurality of like blister packages or other packages of Restoril capsules (not shown).

The group of medications 23 include medications designated on the medication order such as the display 14 so that the student or other user may select from the medications in the kit 10, or others on hand. The kit 10 includes only oral medications, but it is to be understood that injectable or other medications are also contemplated within the true spirit and scope of the present invention.

Considering a method of evaluating the proper administration of medication according to an embodiment of the invention, assume that the student or user commences by reviewing a medication order display such as the display 14.

Considering now a method of using the kit 10 in accordance with an embodiment of the invention as shown in FIG. 3, assume for example the user, such as a student, would review the information contained in the medication order display 14 for a hypothetical medical patient as indicated on a patient name indicia 35 for a patient “JACK SMITH.”

The physician's orders display 14 includes a variety of different medications to be administered to this patient. For example, for the Prilosec medication indicia 15 includes a dose indicia 34 of 20 mg is provided for a route indicia 36 of “PO” (by mouth) and a frequency indicia 38 of “qid” (four times per day). In the present example, assume that the frequency of “qid” is deliberately incorrect for this medication for testing purposes. The student should recognize this and determine that an incorrect frequency has been ordered.

Similarly, a Colace medication indicia 41 is provided, but no dose indicia is given. Thus, this inaccurate or incorrect order is deliberately provided to test the student to identify such mistakes.

A medication indicia 43 for “MVI” (multi-vitamin) does not have a corresponding frequency indicia. Thus, this is an incorrect order, which should be identified as such by the student or other user.

Furthermore, a medication indicia 45 for Persantine fails to have a corresponding route. Hence, the student or other user is being asked to determine that the complete administration information is not provided, and thus is an incorrect order.

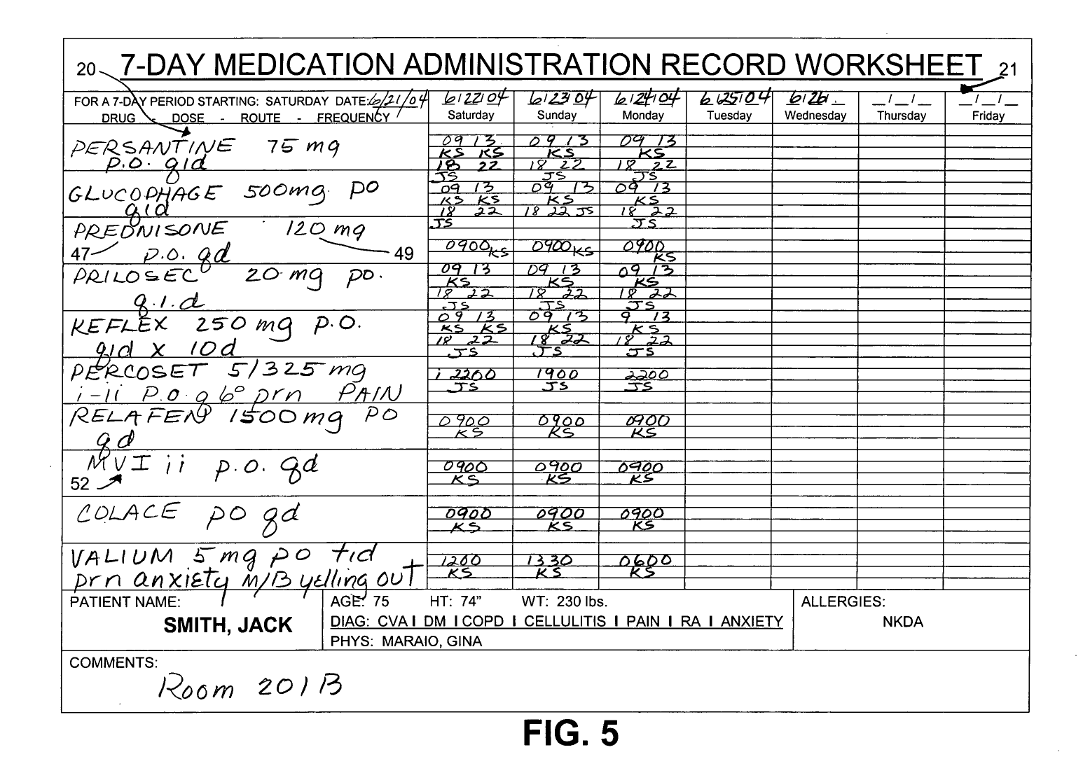

As shown in FIG. 5, the student will then transcribe the physician's orders on the medication administration record worksheet display in the transcription area generally indicated at 20. In so doing, the student or other user should correct any mistakes in the physician order to ensure the proper administration of the medications. A medication indicia 47 for Prednisone includes a dose indicia 49 in the form of 120 mg, which is an incorrect transcription of the physician's order on the order display 14. In this regard, it is shown in FIG. 3, a dosage indicia 50 indicates “20 mg”. Thus, the student or other user incorrectly transcribed the order in connection with the dosage. Due to the inaccurate or incorrect transcription of the order, an incorrect dosage was administered to the patient and the patient received the dosage incorrectly.

Similarly, a medication indicia 52 in the form of “MVI ii” is an indication for a particular type of multi-type vitamin. However, it is an incorrect transcription of the physician order. In this regard, referring to FIG. 3, the correct order is shown in the medication indicia 43 as being “MVI i”. Thus, an incorrect administration of this medication was given and has been administered for 3 days with the wrong dose.

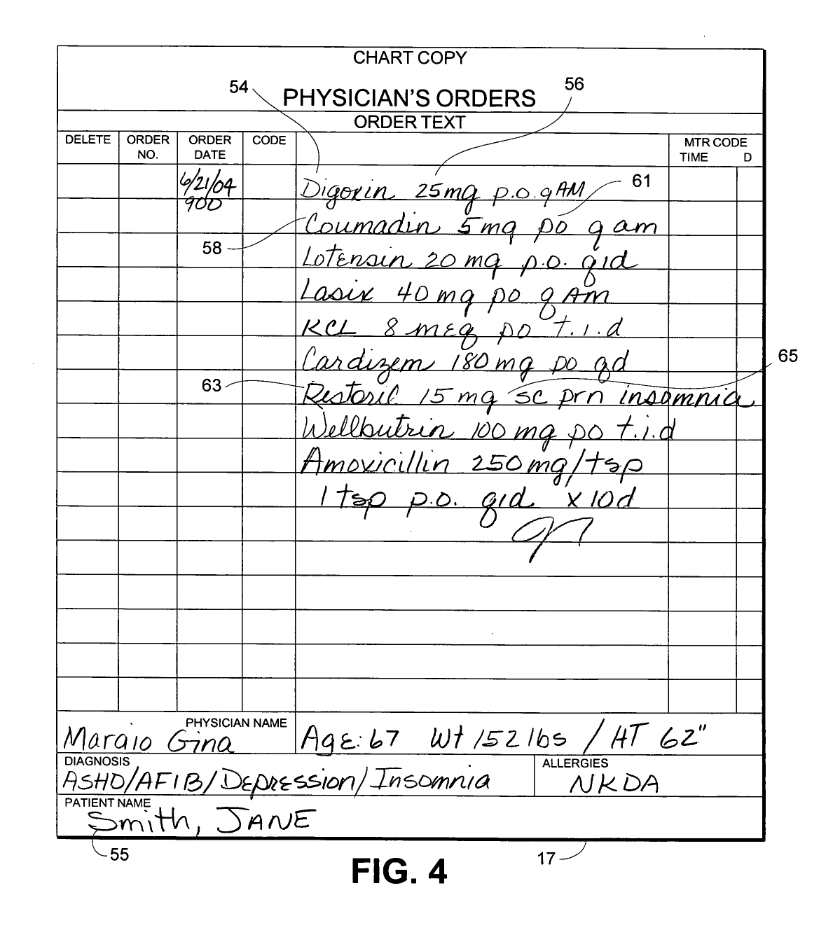

As shown in FIG. 4, the student may also be called upon to administer medications to another patient. In the physician's orders display 17, for a patient “JANE SMITH” shown in the patient named indicia 55 a medication indicia 54 for the Digoxin indicates a dose indicia 56 in the form of 25 mg. This is an incorrect over dosage as written by the physician. Similarly, a medication indicia 58 for Coumadin indicates a frequency indicia 61 of 9AM, which is incorrectly given in a deliberate manner to test the student or other user.

A medication indicia 63 of Restoril and as an administration of a route indicia 65 of “sc” indicates a medication to be injected, which is incorrectly written since it should be given by mouth.

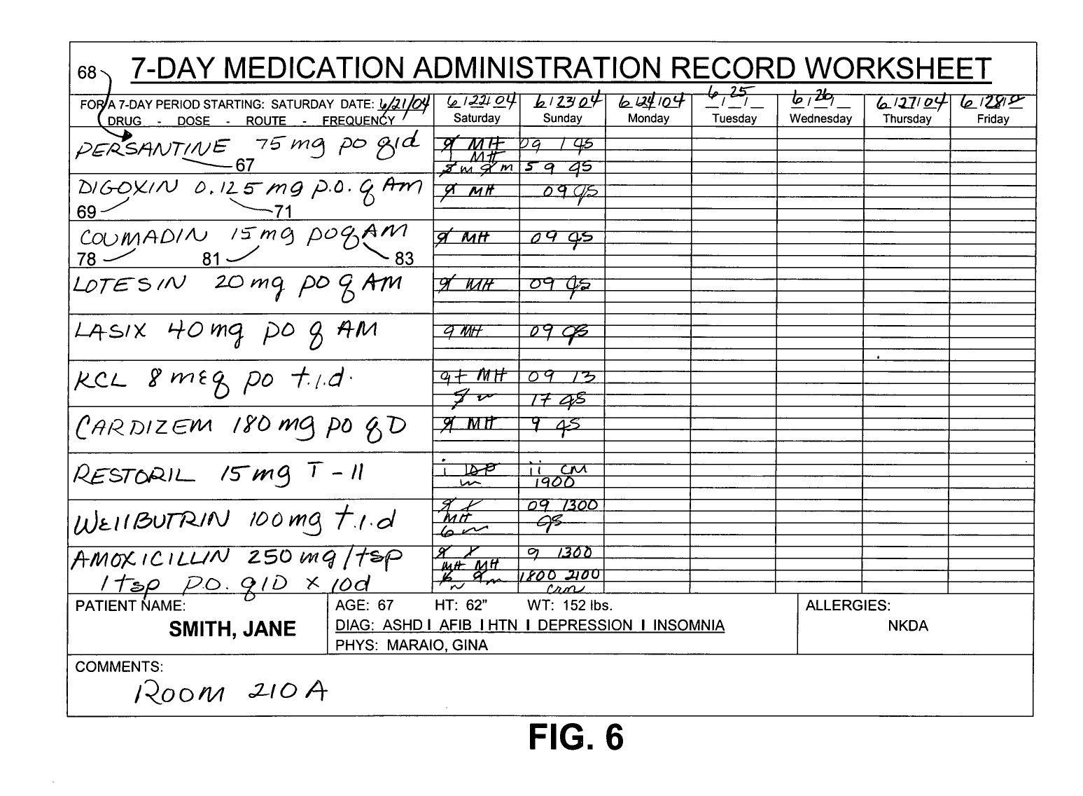

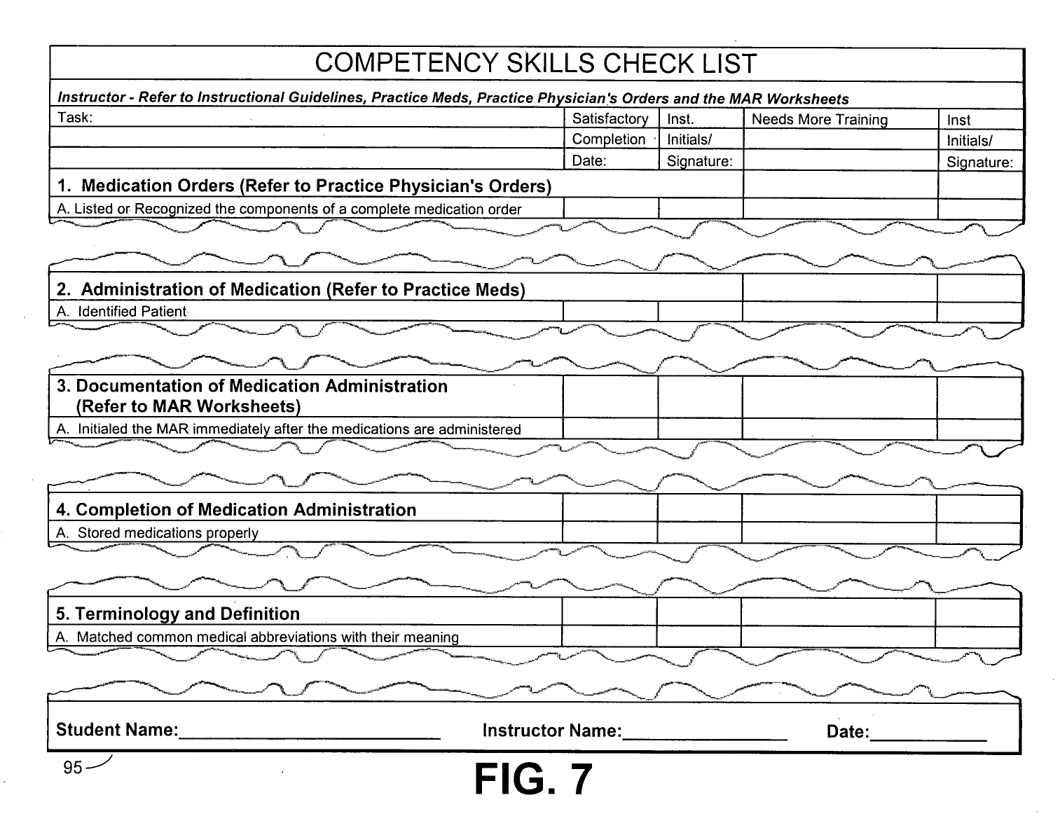

Referring now to FIG. 6, the physician order shown in the display 17 is transcribed in a transcription area 68. For example, a medication indicia 67 for Persantine is indicated as being entered by the student. However, this represents an incorrect medication for this patient. It may have been copied mistakenly from another patient's physician's orders such as the display 14 of FIG. 3.

The display 6 also indicates a medication indicia 69 of Digoxin as being transcribed for a dose indicia 71 of 0.125 mg. It should be noted that the student or other user correctly identified an incorrect order on the physician's order display 17 of FIG. 4, which indicated a dose of 25 mg in the dose indicia 56. Thus, the student correctly identified the mistaken order and corrected it in a proper manner.

A medication indicia 78 for Coumadin shows a dose indicia 81 of 15 mg and a frequency indicia 83 of “qAM”. Both the dose indicia 81 and the frequency 83 are incorrectly transcribed, and thus incorrect medication administration is then given. The student or user would determine if the ordered medications are within normal ranges by referencing the physician's orders on the display 14 with the normal dosage listed in standard sources such as the “Physician's Desk Reference,” or similar medication dosage guide. The ordered medications are then located, and the expiration dates are then checked. For example, reference may be made to FIG. 2 for the medication Restoril where the expirations are listed.

The correct patient must then be identified for whom the medications are ordered by checking an ID that is BANNED (not shown) on the hypothetical or other patient with the patient name indicia 35 for the patient “JACK SMITH.”

The user or student must confirm that this is the right patient, the correct drug, the correct dose, the correct route and the correct time. Originally, the user/student may conduct appropriate physical checks such as pulse, blood pressure, weight and other, before opening the unit that those packages or boxes generally indicated at 23 and FIG. 1.

The student or user must demonstrate aseptic technique while preparing the correct dosage for administration. This may require breaking of scored tablets, reconstitution of powdered agent and pouring liquid for simulated solution such as amoxicillin solution, and others.

The administered medications should be properly charted on the correct medication administration work sheet. In this regard, two patient models, with similar names and similar room numbers, have been provided for test purposes. All of the test medications should be safely and appropriately disposed of following the exercise.

The student or other user is encouraged to take proper administrative precautions. For example, digoxin may include the reminder “check pulse,” or “do not administer if P below 60.”

As students or other users are preparing the medication for administration, they are instructed to first locate the box which holds the medication ordered, then do a second check to be sure the unit dosage package, such as the package 29 (FIG. 2), inside the unit dose box 32, is correct. The expiration date on the package is checked. The dosage ordered must then be prepared. Note that the medication may be ordered in a different unit of measure—or different dosage that must be converted, i.e.: digoxin may be ordered 0.125 mg requiring the 0.25 tablet to be broken in half, and the amoxicillin is ordered per teaspoon, requiring conversion from milliliters. Each student learns to break scored tablets and pour liquid medication. Actual opening of unit dosage packages and handling of medications using proper aseptic technique may be an important learning experience.

A complete Competency Skills Checklist display 95 for evaluating each student's laboratory pre-clinical performance. The following may be the content contained in the display 95:
1. Medication Orders (Refer to Physician's Orders 14 and 16)
   A. Listed or Recognized the components of a complete medication order
   B. Transcribed orders onto the MAR Worksheet
      1. Used proper abbreviations
      2. Calculated stop dates correctly
      3. Transcribed PRN orders appropriately
      4. Copied orders completely and legibly
      5. Discontinued orders properly
   C. Checked original Physician's Orders against transcribed MAR worksheets for accuracy
   D. If Physician's Orders were unclear—followed appropriate protocol
   E. Identified required information on the medication label
2. Administration of Medication (Refer to practice medications 23)
   A. Identified Patient
   B. Gathered appropriate equipment and keeps equipment clean
   C. MAR utilized when medications are administered and also when medications are prepared or poured (if pouring is allowed)
   D. Read the label 3 times; Label is checked against order on Physician's Order and MAR
   E. Used aseptic technique when pouring and preparing medications into appropriate container
   F. Utilized Special Administration/Monitoring Techniques as indicated (vital signs, crush meds, check blood sugar, mix with liquid, etc.)
   G. Administered medications using all of the 6 rights (right patient, right drug, right dose, right route, right time and right documentation)
   H. Described methods used to monitor a patient's condition and reactions to medications and what to do when there appears to be a change in the patient's condition or health status
   I. Utilized appropriate hand-washing technique and infection control principles during medication pass
3. Documentation of Medication Administration (Refer to MAR Worksheets 19 and 22)
   A. Initialed the MAR immediately after the medications are administered
   B. Documented medications that are refused, held, or not administered appropriately.
   C. Administered and documented PRN medications appropriately
4. Completion of Medication Administration
   A. Stored medications properly
   B. Disposed of contaminated or refused medication
   C. Rechecked MARs to make sure all medications had been given and documented
   D. Maintained security of medications during medication administration
   E. Stored controlled substances appropriately and counted and signed controlled substances per facility policy/form
   F. Assured medication room/cart/cabinet is locked when not in use
5. Terminology and Definition
   A. Matched common medical abbreviations with their meaning
   B. Listed/Described common dosage forms of medications and routes of administration
   C. Listed the 6 rights of medication administration (right patient, right drug, right dose, right route, right time and right documentation)
   D. Described what constitutes a medication error and actions to take when a medication error is made or detected.
   E. Described patient's rights regarding medications, i.e., refusal, privacy, respect
   F. Defined medication “allergy”
   G. Demonstrated the use medication resources or references, i.e., Drug Handbook, PDR

The foregoing information which may be contained in the display 95, is a more complete description of the method which may be followed by the student or teacher. The teacher is instructed to enter information in the check list display 95 to record information concerning the performance of the user.

While the present embodiments of the invention disclosed herein have been particularly shown and described with reference to particular embodiments thereof, it will be understood by those skilled in the art that various changes in form and details may be made therein without departing from the true spirit and scope of the present invention. For example, while the kit 10 and the methods disclosed herein relate to testing students, it will become apparent to those skilled in the art that the kit and method of the present invention may be used for other purposes such as monitoring actual administration of real medications. Also, the terms “medication” or “medications” shall include practice medications, which are imitations of real medications and are not intended for human or animal ingestion or injection.

What is claimed is:

1. A method for evaluating the proper administration of medications, comprising:
providing at least one medication order display bearing medication indicia and administration indicia;
providing at least one medication administration record worksheet display bearing a transcription area and a medication administration record area;
providing a group of medications including medications designated by the medication indicia;
instructing the user to enter information in the transcription area of the worksheet based on the medication indicia and administration indicia of the order display; and
instructing the user to enter information in the medication administration record area based on the transcription information and selected ones of the practice medications.

2. A method according to claim 1, wherein said medication indicia is incorrect.

3. A method according to claim 1, wherein said administration indicia is incorrect.

4. A method according to claim 1, wherein the administration indicia includes dose indicia.

5. A method according to claim 1, wherein said administration indicia includes route indicia.

6. A method according to claim 1, wherein the administration indicia includes frequency indicia.

7. A method according to claim 1, further including providing a competency skills check list display, and instructing a teacher to enter information in the check list display to record information concerning the performance of the user.

8. A kit for evaluating proper administration and medications, comprising:
at least one medication order display bearing medication indicia and administration indicia;
at least one medication administration record worksheet display bearing a transcription area and a medication administration record area; and
a group of practice medications including medications designated by the medication indicia.

9. A kit according to claim 8, further including a competency skills check list display.
